(19) United States
(12) Patent Application Publication
(10) Pub. No.: US 2015/0043223 A1
(43) Pub. Date: Feb. 12, 2015

(54) LED Recessed Lighting Device

(71) Applicant: Michael CHEN, Whitier, CA (US)

(72) Inventor: Michael CHEN, Whitier, CA (US)

(21) Appl. No.: 13/960,956

(22) Filed: Aug. 7, 2013

(51) Int. Cl. F21V 21/04; F21K 99/00

(52) U.S. Cl. CPC F21V 21/049; F21K 9/30
USPC 362/365

(57) ABSTRACT

Present invention teaches to the construction of a LED lighting device where a LED light module and a retention piece will be placed inside an outer cover and a receiving tray, which can then be assembled to a commercially available junction box, instead of an extra can or bucket, resulting in reduced space requirement for the installation of recessed lighting.

### FIELD AND BACKGROUND OF THE INVENTION

Recessed lighting, usually installed on the ceiling or into walls at a spot elevated from ground level, has been on the market for a long time. The common and prevalent way of installing recessed lighting is to cut into ceiling or walls, form an empty cavity, put in a metal “can” or “bucket” with wiring connection points or terminals, and install lights to the can or the bucket.

The common way of the installation generally requires sufficient depth behind the wall or above the ceiling, in the range of twelve to eighteen (12-18) inches, in order for a recessed light to be put in place. Sometimes, the existence of supporting structures, such as beans, studs, or columns, or other conduits/pipes would pose additional technical issues to the installation, due to the effective reduction of workable space.

The prevalent way of installing recessed lighting thus is expensive and voluminous, as a result of the mandatory use of the bucket or can.

With the advent of new lighting technology, such as LED light, some in the industry also start to use LED light source, instead of the traditional incandescent, florescent or compact-florescent (CF) light source, for putting into the inner volume of the can or bucket.

The present invention will dramatically benefit the industry of recessed lighting and installation industry, thanks to its overall compact size, easier to install and the cost-reduction as a result thereto.

### OBJECTS AND SUMMARY OF THE INVENTION

The present invention relates generally to recessed lighting devices containing LED light modules. Particularly, present invention reduces the overall size of recessed lighting, by its structural connection to commonly available junction boxes.

The present invention's construction allows the LED light modules to become compact yet with good heat-dissipating features and reduces the cost of installation greatly, as compared to the current models on the market.

Relying on the use of a separate can or bucket unit to install the recessed lighting, the traditional way of recessed lighting is more expensive and takes up huge in-room space. In the case where there is low ceiling or reduced in-room space, the traditional recessed lighting installation would create more of a cost and construction problem.

By the use of the LED recessed lighting and pursuant to the teachings of present application, there is no need for a separate can or bucket. Instead, industry standard junction boxes are used to hold the LED light module. As such, the in-room space, including the ceiling space needed or the behind-the-wall space needed, is greatly reduced for the installation of LED recessed lighting devices made pursuant to the teachings of present application, resulting in overall lower cost of construction.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows an elevated exploded view of the components making up the LED light device of present application.

FIG. 2 shows an elevated exploded view, as seen from the direction opposite from FIG. 1, of the components making up the device of present application.

FIG. 3 shows the side view of the device with a small gap of 2 mm.

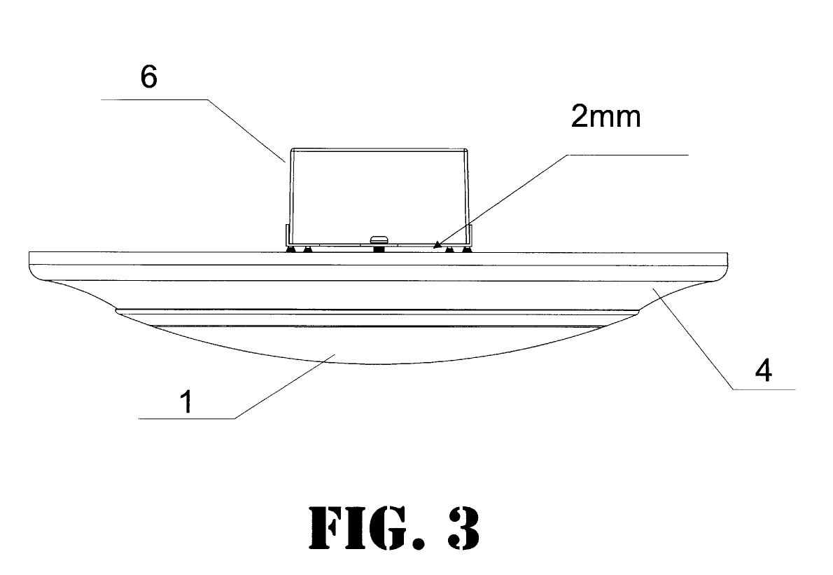

FIG. 4 shows a partial assembled view of the LED lighting device.

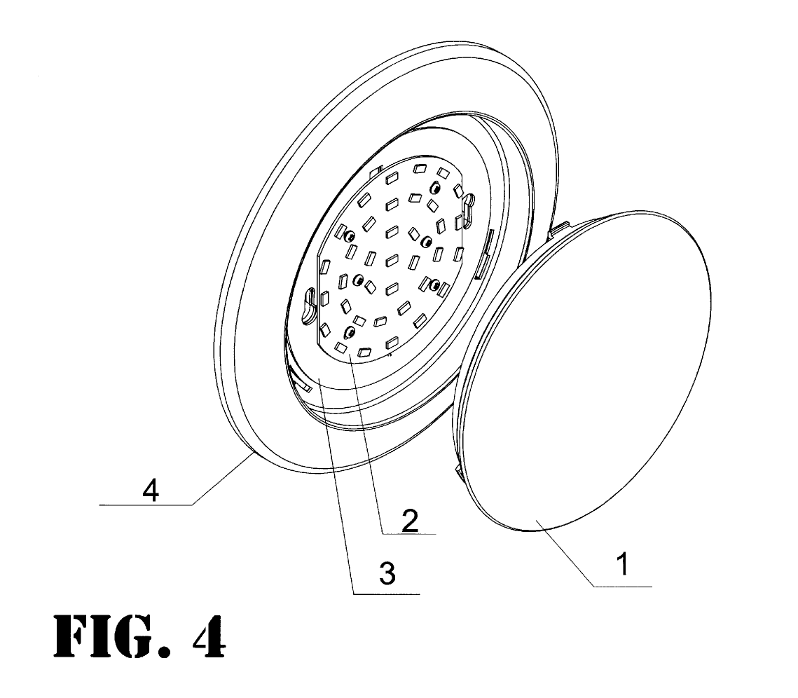

### DETAILED DESCRIPTION OF THE PREFERRED EMBODIMENT

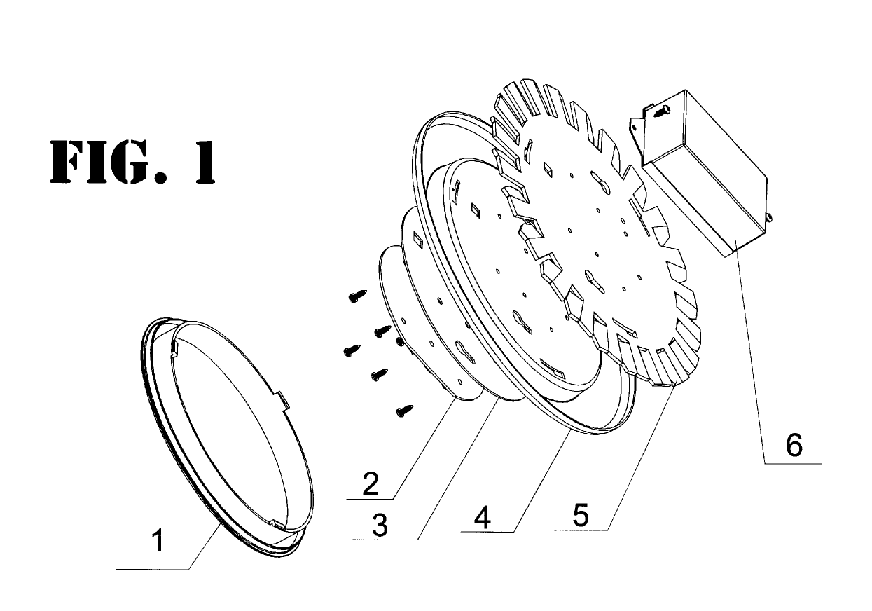

As shown in FIG. 1, the LED recessed light device is made up of a generally round and disc-shaped outer cover 1, a LED light module PCB 2, a PCB retention piece 3 and a receiving tray 4.

Said LED light module PCB 2 is attached to said PCB retention piece 3. Such attachment can be made by the use of screws and corresponding screw holes, small protruding tabs to “click” into corresponding notches, or by means of glue, preferably glue with good heat-dissipating characteristics.

Said PCB retention piece 3 is made of generally rigid material and has good heat-dissipating quality. As an example for the disclosure, and not for limiting purpose, aluminum sheeting material can be used to make said PCB retention piece.

The receiving tray 4 has a front side and a back side. The front side is generally shaped like the inside area of a shallow dish and is sized to receive said outer cover 1, with the LED light module PCB 2 and the PCB retention piece 3 inside the cavity area in between the enclosure space defined by said outer cover 1 and the receiving tray 4.

On the back side of said receiving tray 4, an optional heat sink piece 5 may be attached.

On the back side of said receiving tray 4, a LED driving module 6 is attached in a way that a small gap of roughly 2 mm exists, between said LED driving module 6 and the back side of said receiving tray 4. Such a small gap shall be a minimum of roughly 2 mm.

This air gap can be made bigger, as long as it is within the allowed space when installed to a junction box.

If the optional heat sink piece 5 is in place (attaching to the back side of said receiving tray 4), the small gap, of roughly 2 mm at the minimum, would exist between said LED driving module 6 and the heat sink piece 5.

The small gap is made to be the size of roughly 2 mm, to provide the air way for heat dissipation. It can be made larger than 2 mm, depending on allowable size restriction for the junction box size selected.

Said LED driving module 6 is made with a size that it can be fitted to the inside volume of a junction box that is generally available on the market.

To the extent there are different shapes and sizes of commercially available junction boxes, the LED driving module 6 can be made to match the inner volume of the junction box chosen for use.

A plurality of holes are made through said PCB retention piece 3 and said receiving tray 4, so that screws can be employed to secure said PCB retention piece 3 and said receiving tray 4 to a junction box that's commonly available on the market.

If the optional heat sink piece 5 is used, it would contain matching holes allowing the same screwing mechanism to work and secure the LED recessed light device to a junction box.

Some optional and additional holes can be made to said PCB retention piece 3, said receiving tray 4, and the optional heat sink disc 5, to increase air circulation and cooling effect.

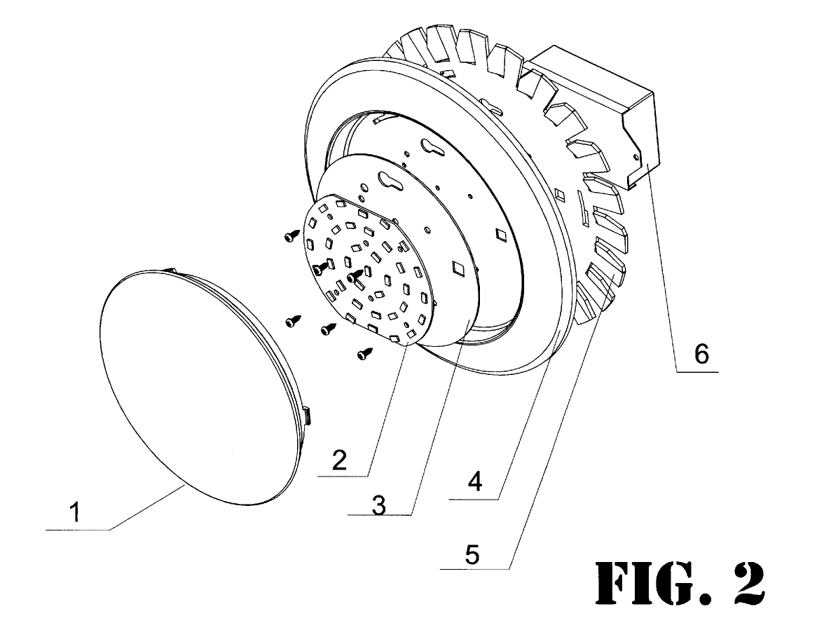

Said outer cover 1 contains a ring of lip, as shown in FIG. 2. A plurality of tabs are made on said ring of lip and can be inserted into corresponding notches built in said receiving tray 4, so that when fully assembled, only the outside surface of said outer cover 1 can be seen by consumers and all the LED light module PCB 2, PCB retention piece 3, screws and holes are blocked from consumers' view.

These notches can be made to have extended hollow portion, so as to create some passageways for air circulation and heat dissipation. Additionally, some holes may be made on said receiving tray 4 and said PCB retention piece, so as to further aid the air circulation and heat dissipation.

Note that a LED recessed light device can be made pursuant to the teaching of present application while the outer cover 1 can be in an oval shape, square, rounded square or rectangular shape, as long as the corresponding receiving tray 4 is made to have the matching shape(s).

What is claimed is:

1. A LED recessed light device, comprising:
a. A LED light module PCB;
b. A PCB retention piece;
c. A receiving tray having a front side and a back side;
d. A LED driver module attachable to the back side of said receiving tray, said LED driving module is sized to fit within the inner volume of a junction box;
e. a plurality of screw holes made through said PCB retention piece and said receiving tray enabling connection by screw means to a junction box; and,
f. a generally round and disc-shaped outer cover for connecting to the front side of said receiving tray, blocking said LED light module PCB, said PCB retention piece and the screws from view.

2. The LED recessed light device of claim 1, wherein the attachment of said LED driver module to the back side of said receiving tray is made to have a small gap of 2 mm at the minimum.

3. The LED recessed light device of claim 1, further comprising a round heat sink piece attachable to the back side of said receiving tray, so that it is situated between said receiving tray and said LED driver module when assembled, with a similar small gap existing in between said LED driver and said heat sink piece.

4. The LED recessed light device of claim 1, wherein said outer cover may be in a shape other than the generally round shape, as long as said receiving tray is made to have a matching front side for receiving said outer cover.

5. The LED recessed light device of claim 1, wherein said PCB retention piece is made of aluminum sheeting material.

6. The LED recessed light device of claim 1, wherein said outer cover contains a ring of lip having a plurality of tabs that can be wedged into corresponding notches built in said receiving tray.

7. The LED recessed light device of claim 6, wherein said notches can be made to have extended hollow portion, to create some passageways for air circulation and heat dissipation.

8. The LED recessed light device of claim 6, wherein the some holes may be made on said receiving tray and said PCB retention piece to further aid the air circulation and heat dissipation.
